(19) United States
(12) Patent Application Publication
(10) Pub. No.: US 2015/0109174 A1
(43) Pub. Date: Apr. 23, 2015

(54) WEARABLE COMMUNICATION DEVICE

(71) Applicant: Acer Incorporated, New Taipei City (TW)

(72) Inventor: Chih-Hua Chang, New Taipei City (TW)

(73) Assignee: Acer Incorporated, New Taipei City (TW)

(21) Appl. No.: 14/246,149

(22) Filed: Apr. 7, 2014

(30) Foreign Application Priority Data
Oct. 23, 2013 (TW) 102138280

(51) Int. Cl. H01Q 1/27; G02C 11/00; G04R 60/04

(52) U.S. Cl. CPC H01Q 1/273; G04R 60/04; G02C 11/10
USPC 343/718

(57) ABSTRACT

A wearable communication device including a carrier, a ground plane and a coaxial cable is provided. The carrier includes an insulation portion. The ground plane is fixed on the carrier. The coaxial cable is fixed on the carrier and generates a resonant mode. Besides, the coaxial cable includes an outer conductor and an inner conductor. The outer conductor is electrically connected to the ground plane. The inner conductor includes a feeding point and a first conduction section exposed outside the outer conductor. The first conduction section is opposite to the insulation portion, and a length of the first conduction section is related to a center frequency of the resonant mode.

### CROSS-REFERENCE TO RELATED APPLICATION

This application claims the priority benefit of Taiwan application serial no. 102138280, filed on Oct. 23, 2013. The entirety of the above-mentioned patent application is hereby incorporated by reference herein and made a part of this specification.

### BACKGROUND OF THE INVENTION

1. Field of the Invention

The invention relates to a communication device, and more particularly, to a wearable communication device.

2. Description of Related Art

With rapid growth of mobile communication technology, various international companies have begun to develop wearable communication devices. A wearable communication device integrates functions of wireless/mobile communication onto the wearable devices (e.g., watches, glasses and so forth) for users to carry and operate. In addition, overall environment (e.g., exterior design, antenna space, ground plane size, and antenna surroundings) for the wearable communication device is far different from that for existing hand-held devices. Therefore, the wearable communication device needs to apply different design concepts and technologies in designing an antenna element.

For instance, because the wearable communication device will become one of accessories wore by the users in practical applications, an exterior structure must also be considered in addition to functionalities of the wearable communication device. Accordingly, inner elements (e.g., the antenna element) of the wearable communication device are required to be highly flexible in terms of design in order to match the exterior structure of the wearable communication device. In other words, how to dispose the antenna element in response to various exterior structures of the wearable communication device is an important issue in designing the wearable communication device.

### SUMMARY OF THE INVENTION

The invention is directed to a wearable communication device which forms an antenna element by utilizing a coaxial cable, so that the antenna element may be disposed in compliance with an exterior structure of the wearable communication device.

A wearable communication device of the invention includes a carrier, a ground plane and a coaxial cable. The carrier includes an insulation portion. The ground plane is fixed on the carrier. The coaxial cable is fixed on the carrier and generates a resonant mode. Besides, the coaxial cable includes an outer conductor and an inner conductor. The outer conductor is electrically connected to the ground plane. The inner conductor includes a feeding point and a first conduction section exposed outside the outer conductor. The first conduction section is opposite to the insulation portion, and a length of the first conduction section is related to a center frequency of the resonant mode.

Based on above, the invention forms the antenna element by utilizing the coaxial cable. Therefore, the antenna element constituted by the coaxial cable can be bent in compliance with a shape of the carrier. Accordingly, the antenna element may be disposed in compliance with the exterior structure of the wearable communication device, so as to facilitate in improving design flexibility of the wearable communication device.

To make the above features and advantages of the disclosure more comprehensible, several embodiments accompanied with drawings are described in detail as follows.

### BRIEF DESCRIPTION OF THE DRAWINGS

FIG. 1 is a schematic diagram of a wearable communication device according to an embodiment of the invention.

FIG. 2 is a side view of the wearable communication device of FIG. 1.

FIGS. 3 and 4 are diagrams for illustrating return loss diagram and antenna efficiency of the antenna element of the embodiment of FIG. 2.

FIG. 5 is a schematic diagram of a wearable communication device according to another embodiment of the invention.

FIG. 6 is a schematic diagram of a wearable communication device according to another embodiment of the invention.

FIG. 7 is a schematic diagram of a wearable communication device according to another embodiment of the invention.

FIG. 8 is a schematic diagram of a wearable communication device according to another embodiment of the invention.

### DESCRIPTION OF THE EMBODIMENTS

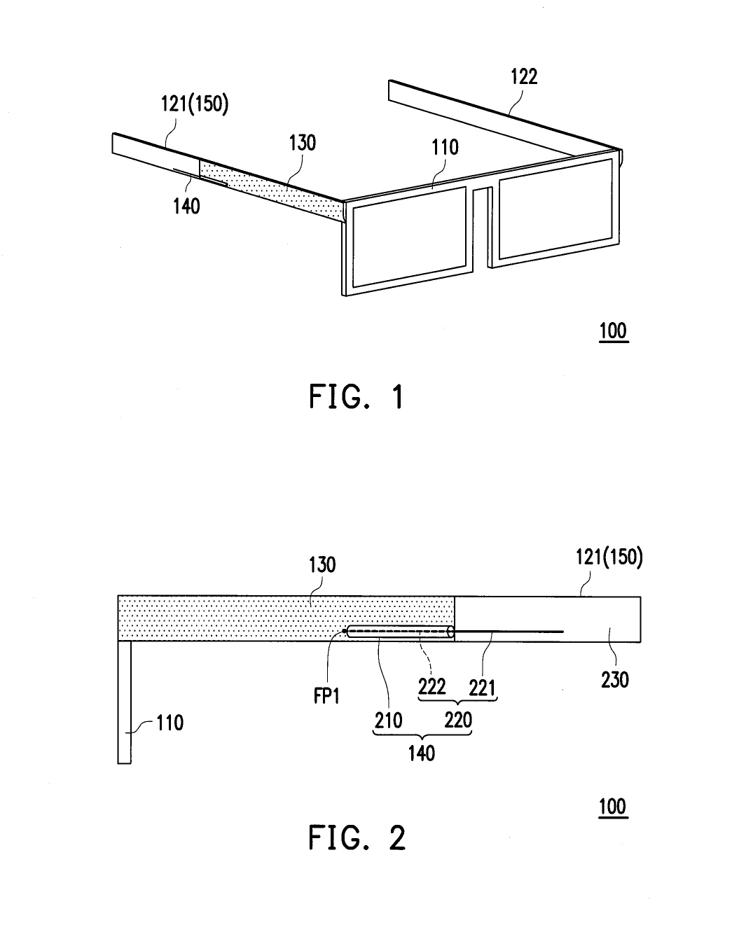

FIG. 1 is a schematic diagram of a wearable communication device according to an embodiment of the invention. A wearable communication device 100 depicted in FIG. 1 is a smart glasses. Accordingly, an exterior structure of the wearable communication device 100 is mainly constituted by a frame 110, a bracket 121 and a bracket 122. In addition to the exterior structure, the wearable communication device 100 further includes a ground plane 130 and a coaxial cable 140.

With respect to the wearable communication device 100, the bracket 121 constitutes a carrier 150 configured to accommodate other elements. For instance, the ground plane 130 and the coaxial cable 140 may be fixed on the carrier 150 (i.e., the bracket 121). In other words, the carrier 150 (i.e., the bracket 121) may be used to carry the ground plane 130 and the carrier 140. Similarly, circuit elements (e.g., processors, radio frequency modules, sensors, batteries, lenses, buttons, touch pads and so forth) in the wearable communication device 100 may also be fixed on the carrier 150 (i.e., the bracket 121).

The wearable communication device 100 forms an antenna element by using the coaxial cable 140. Accordingly, during operations, the wearable communication device 100 may generate a resonant mode through the coaxial cable 140 thereby transceiving an electromagnetic wave. It should be noted that, the coaxial cable 140 is flexible. Therefore, the antenna element formed by the coaxial cable 140 can be bent in compliance with a shape of the carrier 150. In other words, the antenna element formed by the coaxial cable 140 may be disposed in corresponding to the exterior structure of the wearable communication device 100, so as to facilitate in improving design flexibility of the wearable communication device 100. In addition, a complexity in manufacturing the antenna may be lowered by using the coaxial cable 140 to form the antenna element, so as to further facilitate in lowering manufacturing costs and assembling costs of the wearable communication device 100.

In order to further illustrate the antenna element formed by the coaxial cable 140 in FIG. 1 to one skilled in the art, FIG. 2 is a side view of the wearable communication device of FIG. 1. As shown in FIG. 2, the coaxial cable 140 includes an outer conductor 210 and an inner conductor 220. The outer conductor 210 is electrically connected to the ground plane 130. Further, the inner conductor 220 includes a conduction section 221 and a conduction section 222.

The conduction section 221 is exposed outside the outer conductor 210, and the conduction section 222 is covered by the outer conductor 210. In other words, the outer conductor 210 merely surrounds the conduction section 222, so that the coaxial cable 140 exposes the conduction section 221. Furthermore, a first terminal of the conduction section 222 has a feeding point FP1, and a second terminal of the conduction section 222 is electrically connected to the conduction section 221. Further, the carrier 150 (i.e., the bracket 121) includes an insulation portion 230. That is, a part of the carrier 150 is formed by a non-conductive material. Further, the conduction section 221 is opposite to the insulation portion 230, and a length of the conduction section 221 is related to a center frequency of the resonant mode. On the other hand, the ground plane 130 and the coaxial cable 140 may be, for example, embedded inside the carrier 150 (i.e., the bracket 121).

During operations, the wearable communication device 100 may transmit a feeding signal to the feeding point FP1, and emit the electromagnetic wave through the coaxial cable 140. Accordingly, the wearable communication device 100 may sense electromagnetic energy in space through the coaxial cable 140, so as to achieve the function of receiving the electromagnetic wave. It should be noted that, the antenna element formed by the coaxial cable 140 has a monopole antenna structure in the embodiment of FIG. 2. For instance, in FIG. 2, the first terminal of the conduction section 211 is adjacent to the outer conductor 210, and the second terminal of the conduction section 221 is an open terminal. In addition, a length of the conduction section 221 is 0.2 times a wavelength of the center frequency of the resonant mode. Accordingly, the conduction section 221 may be used to form the monopole antenna structure, such that the wearable communication device 100 may be operated in a communication frequency band through the coaxial cable 140.

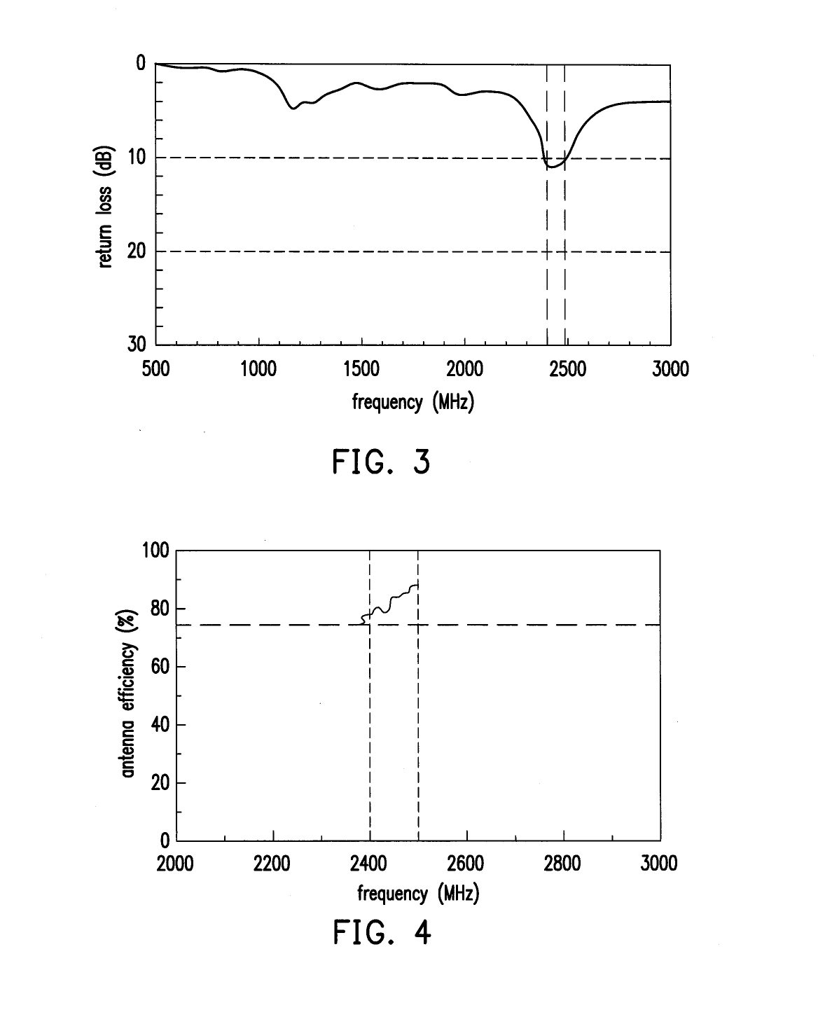

For instance, FIGS. 3 and 4 are diagrams for illustrating return loss diagram and antenna efficiency of the antenna element of the embodiment of FIG. 2. In the embodiments of FIGS. 3 and 4, a volume of the frame 110 is approximately 130×35×1 mm³, and sizes of the two brackets 121 and 122 are approximately 130×3 mm², respectively. In addition, an area of the ground plane 130 is approximately 80×7 mm²; a length of the coaxial cable 140 is approximately 60 mm; and a length of the conduction section 221 is approximately 32 mm. Accordingly, as shown in FIG. 3, the wearable communication device 100 may be applied in a wireless local area network (WLAN) through the coaxial cable 140. In addition, in case an operation bandwidth is defined by return loss of 10 dB, the operation bandwidth of the antenna element may reach 90 MHz (i.e., 2,395 to 2,485 MHz). In addition, as shown in FIG. 4, antenna efficiency of the antenna element within 2,400 to 2,484 MHz may be higher than 75% to satisfy requirements of actual product.

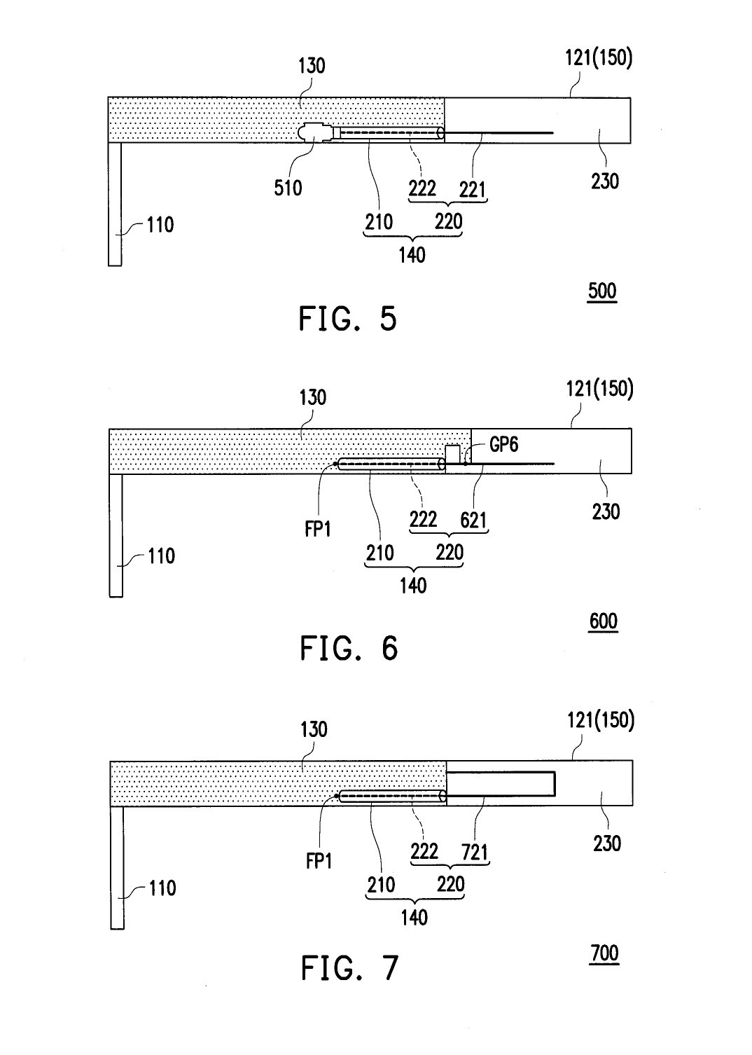

It should be noted that, in practical assembly, the wearable communication device 100 may transmit the feeding signal to the feeding point FP1 of the coaxial cable 140 through a connector. For instance, FIG. 5 is a schematic diagram of a wearable communication device according to another embodiment of the invention. A wearable communication device 500 depicted in FIG. 5 is an extension of the embodiment of FIG. 2, a major difference between the two is that: the wearable communication device 500 further includes a connector 510.

More specifically, the connector 510 is electrically connected to the coaxial cable 140, and engaged with a first terminal of the conduction section 222. Further, the first terminal of the conduction section 222 has the feeding point FP1. In other words, the wearable communication device 500 may transmit the feeding signal to the feeding point FP1 of the coaxial cable 140 through the connector 510 without disposing elastic pieces, pogo pins or other soldering components, additionally. Therefore, manufacturing costs and assembling costs of the wearable communication device 500 may be further lowered.

Besides, although FIG. 2 illustrates an antenna type of the coaxial cable 140, but the invention is not limited thereto. For instance, FIG. 6 is a schematic diagram of a wearable communication device according to another embodiment of the invention. A wearable communication device 600 depicted in FIG. 6 is an extension of the embodiment of FIG. 2, a major difference between the two is that: a conduction section 621 in FIG. 6 is used to form an inverted F antenna structure.

More specifically, a first terminal of the conduction section 621 is adjacent to the outer conductor 210, and a second terminal of the conduction section 621 is an open terminal. In addition, the conduction section 621 further includes a ground point GP6 electrically connected to the ground plane 130, and a length from the ground point GP6 to the open terminal of the conduction section 621 is 0.25 times a wavelength of the center frequency of the resonant mode. Accordingly, the wearable communication device 600 in the embodiment of FIG. 6 may form the antenna element having the inverted F antenna structure by utilizing the coaxial cable 140. Detailed description regarding other components of the embodiment of FIG. 6 has been included foregoing embodiments, thus it is omitted hereinafter.

FIG. 7 is a schematic diagram of a wearable communication device according to another embodiment of the invention. A wearable communication device 700 depicted in FIG. 7 is an extension of the embodiment of FIG. 2, a major difference between the two is that: a conduction section 721 in FIG. 7 is used to form a loop antenna structure.

More specifically, a first terminal of the conduction section 721 is adjacent to the outer conductor 210, and a second terminal of the conduction section 721 is electrically connected to the ground plane 130. In addition, a length of the conduction section 721 is 0.5 times a wavelength of the center frequency of the resonant mode. Accordingly, the wearable communication device 700 in the embodiment of FIG. 7 may form the antenna element having the loop antenna structure by utilizing the coaxial cable 140. Detailed description regarding other components of the embodiment of FIG. 7 has been included foregoing embodiments, thus it is omitted hereinafter.

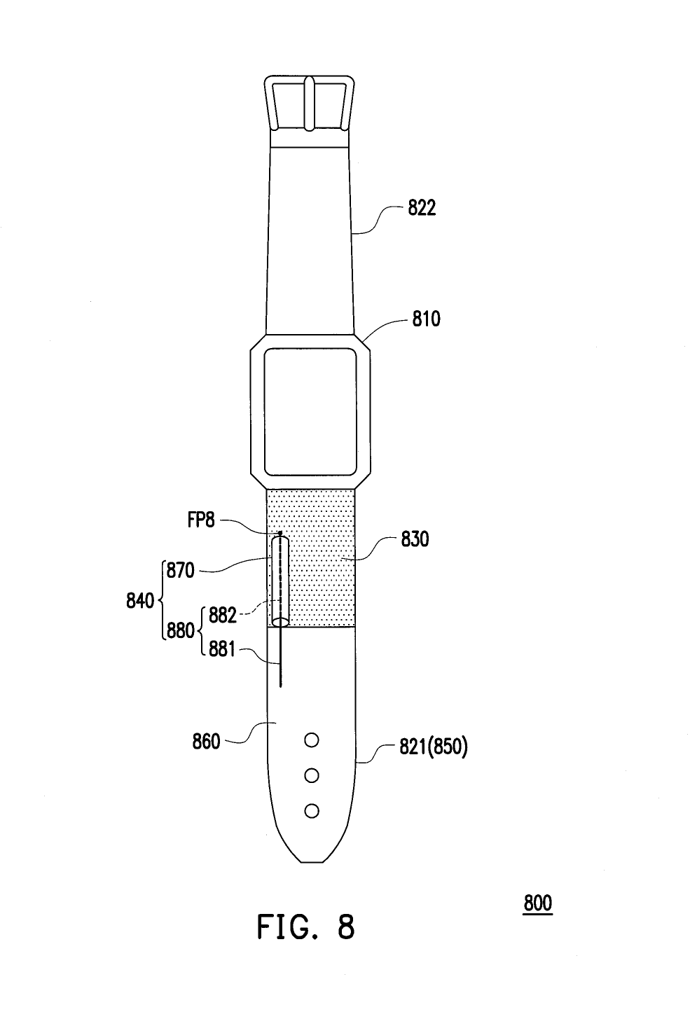

Although the wearable communication device is illustrated by using the smart glasses as an example in each of the foregoing embodiments, but the invention is not limited thereto. For instance, FIG. 8 is a schematic diagram of a wearable communication device according to another embodiment of the invention. A wearable communication device 800 depicted in FIG. 8 is a smart watch. Accordingly, an exterior structure of the wearable communication device 800 is mainly constituted by a watch body 810, a watch belt 821 and a watch belt 822. In addition, the wearable communication device 800 further includes a ground plane 830 and a coaxial cable 840.

With respect to the wearable communication device 800, the watch belt 821 may constitute a carrier 850 configured to accommodate other elements. For instance, the ground plane 830 and the coaxial cable 840 may be fixed on the carrier 850 (i.e., the watch belt 821). Further, the carrier 850 (i.e., the watch belt 821) includes an insulation portion 860 formed by a non-conductive material. In addition, the coaxial cable 840 includes an outer conductor 870 and an inner conductor 880, and the inner conductor 880 includes a conduction section 881 and a conduction section 882. Dispositions of the outer conductor 870 and the inner conductor 880 are similar to the dispositions of the outer conductor 210 and the inner conductor 220 depicted in FIG. 2. Accordingly, as similar to the embodiment of FIG. 2, the wearable communication device 800 may also form the antenna element having a monopole antenna structure, so as to achieve effects identical or similar to that of the wearable communication device 100.

Besides, in practical applications, the wearable communication device 800 may also be disposed with a connector as similar to that in the embodiment of FIG. 5, so as to transmit the feeding signal to a feeding point FP8 of the coaxial cable 840 through the connector. Further, the wearable communication device 800 may also form the inverted F antenna structure or the loop antenna structure by using the conduction section 881 in the inner conductor 880 as similar to that in the embodiments of FIGS. 6 and 7. That is, the wearable communication device 800 may also form the antenna element having the inverted F antenna structure or the loop antenna structure by using the coaxial cable 840, so as to achieve effects identical or similar to that of the wearable communication devices 600 and 700. Detailed description regarding other components of the embodiment of FIG. 8 has been included foregoing embodiments, thus it is omitted hereinafter.

In summary, the invention forms the antenna element by utilizing the coaxial cable. Therefore, the antenna element formed by the coaxial cable can be bent in compliance with a shape of the carrier. Accordingly, the antenna element may be disposed in compliance with the exterior structure of the wearable communication device, so as to facilitate in improving design flexibility of the wearable communication device. In addition, a complexity in manufacturing the antenna may be lowered by using the coaxial cable to form the antenna element, so as to further facilitate in lowering manufacturing costs and assembling costs of the wearable communication device.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A wearable communication device, comprising:
a carrier comprising an insulation portion;
a ground plane fixed on the carrier; and
a coaxial cable fixed on the carrier and configured to generate a resonant mode, wherein the coaxial cable comprises:
an outer conductor electrically connected to the ground plane; and
an inner conductor comprising a feeding point and a first conduction section exposed outside the outer conductor, wherein the first conduction section is opposite to the insulation portion, and a length of the first conduction section is related to a center frequency of the resonant mode.

2. The wearable communication device of claim 1, wherein the first conduction section has a first terminal adjacent to the outer conductor and a second terminal being an open terminal.

3. The wearable communication device of claim 2, wherein the length of the first conduction section is 0.25 times a wavelength of the center frequency of the resonant mode.

4. The wearable communication device of claim 2, wherein the first conduction section further comprises a ground point electrically connected to the ground plane, and a length from the ground point to the open terminal is 0.25 times a wavelength of the center frequency of the resonant mode.

5. The wearable communication device of claim 1, wherein the first conduction section has a first terminal adjacent to the outer conductor and a second terminal of the first conduction section electrically connected to the ground plane, and the length of the first conduction section is 0.5 times a wavelength of the center frequency of the resonant mode.

6. The wearable communication device of claim 1, wherein the inner conductor further comprises a second conduction section surrounded by the outer conductor, and the second conduction section has a first terminal with the feeding point and a second terminal electrically connected to the first conduction section.

7. The wearable communication device of claim 6, further comprising a connector electrically connected to the coaxial cable and engaged with the first terminal of the second conduction section.

8. The wearable communication device of claim 1, wherein the ground plane and the coaxial cable are embedded inside the carrier.

9. The wearable communication device of claim 1, wherein the wearable communication device is a smart glasses, and the carrier is a bracket of the smart glasses.

10. The wearable communication device of claim 1, wherein the wearable communication device is a smart watch, and the carrier is a watch belt of the smart watch.
